(19) United States
(12) Patent Application Publication
(10) Pub. No.: US 2009/0164738 A1
(43) Pub. Date: Jun. 25, 2009

(54) Process Based Cache-Write Through For Protected Storage In Embedded Devices

(75) Inventors: Shabnam Erfani, Kirkland, WA (US); Milong Sabandith, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/963,486

(22) Filed: Dec. 21, 2007

(51) Int. Cl. G06F 12/00

(52) U.S. Cl. 711/142; 711/E12.063

(57) ABSTRACT

A system including a write protected storage device, which utilizes a write cache to hold data intended to be written to the device, determines when data should be allowed to write through to the device instead of being cached. A unique identifier is determined for the requesting process and that identifier is used to check a pre-configured set of processes which have been specified as trusted to write to the device. An exemplary approach uses a dynamic store of process IDs for those processes having made previous requests, a persistent store of application names, and a mapping process to obtain an application name for process IDs which are not yet present in the dynamic store.

### BACKGROUND

The use of embedded processors within devices has become commonplace. They are used in everything from automobiles to kitchen appliances. There are categories of embedded processors which use compact flash or read-only memory as their boot media and random access memory (RAM) for their operating system image. Typical operating systems are designed to save certain state information by writing it back to the boot media. Booting and running an operating system from flash memory involves many write operations that could result in fast chip burnout. If read-only media is used, the write operations required by the operating system fail because of the write protection, preventing the ability to save state information and resulting in operating system shutdown. Even where writing back to the boot media is possible, some embedded devices have strict requirements to prevent changes to the operating system.

One approach which is used to support the above scenarios is to use a write cache to accept and retain information intended to be written to the boot media. One example of this is a feature in Microsoft Windows® XP Embedded known as the File-Based Write Filter (FBWF). This feature provides file system cache capability where all the operating system writes are redirected to RAM, hence enabling boot media protection. However, upon reboot all the cached data in RAM is lost. In some cases this is an acceptable solution. In other cases, there is a need to persist operating system changes so that they are available when the system is next booted. Certain applications may also need to persist data across system shutdown and reboot. Where the boot media is writable, one approach to meeting the need for persistent data is to identify those files, or directories, to which the system is allowed to write. This approach meets the basic need but requires the list of writable (or, alternatively, the non-writable) files to be configured. This list may change as a result of an operating system update or due to the addition of an embedded application which was not previously known to the system administrator. Maintaining the required configuration information in a fielded device can require significant time and effort.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

Various aspects of the subject matter disclosed herein are related to an approach for implementing cache write-through in a write caching system for a protected device. The approach utilizes the identity of the process requesting the write in order to determine whether the data should be written to the device or should be cached.

Other aspects relate to means of identifying the process and of determining whether the process is trusted to write to the device or not. An exemplary approach maps the process ID to an executable file name and then looks up the file name in a preconfigured list of trusted applications.

The approach described below may be implemented as a computer process, a computing system or as an article of manufacture such as a computer program product. The computer program product may be a computer storage medium readable by a computer system and encoding a computer program of instructions for executing a computer process.

A more complete appreciation of the above summary can be obtained by reference to the accompanying drawings, which are briefly summarized below, to the following detailed description of present embodiments, and to the appended claims.

### BRIEF DESCRIPTION OF THE SEVERAL VIEWS OF THE DRAWINGS

FIG. 1 is a block diagram illustrating an exemplary operating environment in which the present disclosure may be implemented.

FIG. 2 is a high level diagram illustrating the flow of data associated with requests to modify protected data.

FIG. 3 is a flow diagram of the disclosed method of determining whether to cache or write-through data.

### DETAILED DESCRIPTION

This detailed description is made with reference to the accompanying drawings, which form a part hereof, and which show, by way of illustration, specific exemplary embodiments. These embodiments are described in sufficient detail to enable those skilled in the art to practice what is taught below, and it is to be understood that other embodiments may be utilized and that logical, mechanical, electrical, and other changes may be made without departing from the spirit or scope of the subject matter. The following detailed description is, therefore, not to be taken in a limiting sense, and its scope is defined only by the appended claims.

### Overview

The present disclosure addresses methods and techniques applicable to write-through memory caching schemes. These are clearly applicable to embedded systems which use storage media such as flash memory for which it is desirable to limit the number of write cycles over the life of the device. They are also applicable to systems, embedded or not, where it is desirable to restrict modifications to persistent data for any reason. One example is an information kiosk system where it is desirable that the system always start in the same configuration after every reboot so as to provide a consistent user experience.

### Illustrative Operating Environment

The subject matter of this disclosure may be described in the general context of computer-executable instructions, such as program modules, executed in an appropriate operating environment by one or more computers or other devices. Generally, program modules include routines, programs, objects, components, data structures, etc. that perform particular tasks or implement particular abstract data types. Typically the functionality of the program modules may be combined or distributed as desired in various embodiments.

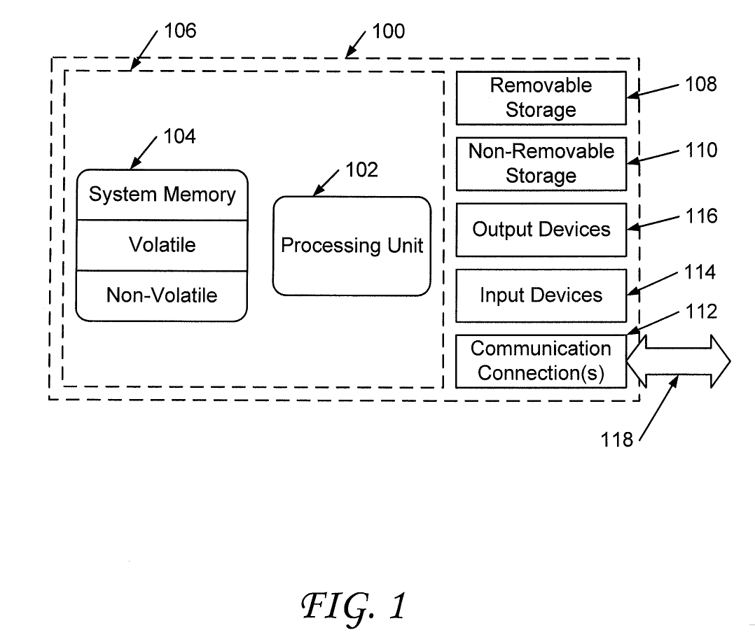

FIG. 1 illustrates one example of a suitable operating environment 100 in which the invention may be implemented. This is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

In its most basic configuration, operating environment 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Further, environment 100 may also include storage devices (removable, 108, and/or non-removable, 110) including, but not limited to, magnetic or optical disks or tape. Similarly, environment 100 may also have input device(s) 114 such as keyboard, mouse, pen, voice input, etc. and/or output device(s) 116 such as a display, speakers, printer, etc. Also included in the environment may be one or more communications interface 112 that connects via Connection 118 to a LAN, WAN, point to point, etc. (not shown). All of these devices are well known in the art and need not be discussed at length here. Where the subject matter of this disclosure is applied to an embedded processor, memory 104 will generally include both volatile and non-volatile memory and storage devices will generally not be present.

Operating environment 100 typically includes at least some form of computer readable media. Computer readable media can be any available media that can be accessed by processing unit 102 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 100 may be a single computer operating in a networked environment using logical connections to one or more remote computers. The remote computer may be a personal computer, a server, a router, a network PC, a peer device or other common network node, and typically includes many or all of the elements described above. The logical connections may include any method supported by available communications media. Such networking environments are commonplace in offices, enterprise-wide computer networks, intranets and the Internet.

### Structure

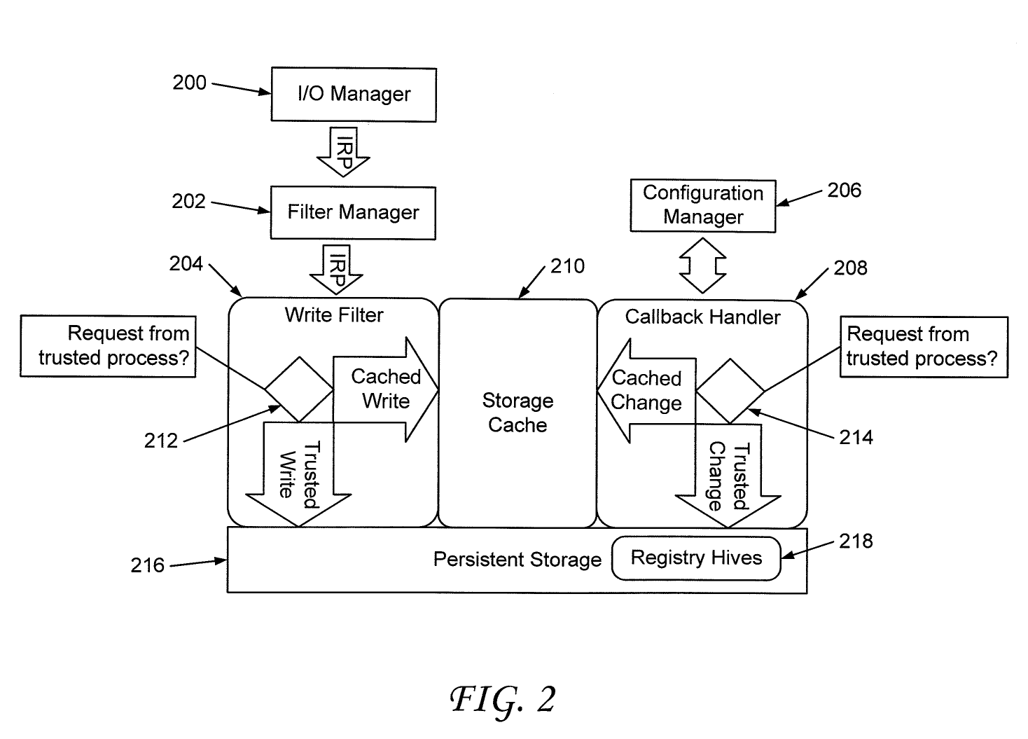

Referring to FIG. 2, an exemplary system architecture is illustrated which supports the concepts of the present disclosure. I/O manager 200 serves as the interface between the system and user mode applications (not illustrated) which make I/O requests of the system. In the context of the present disclosure these are primarily read and write requests for data stored on some type of persistent storage medium 216. The I/O requests are packaged as I/O Request Packets (IRPs). In a different system architecture, there may not be a specific component identified as an I/O manager and I/O requests may be represented in a different manner. However the same general approach will work by using analogous components through which I/O requests are channeled.

As part of the internal processing, each IRP may be passed to the Filter Manager 202. The typical role of the Filter Manager is to manage one or more filters which can optionally be applied to I/O requests. A simple approach is to apply all known filters to all requests. A more elegant solution is to support the ability for each filter to register for the type of I/O operations to which it is to be applied as well as the order in which the filter should be applied relative to the other filters. Then, for each IRP, the Filter Manager identifies which filters are to be applied, the order in which they are to process the IRP, and then activates them.

A write filter 204 will process all write requests, or preferably only those requests for selected storage media. One capability that this enables is the caching of data in a storage cache 210 rather than writing the data to persistent storage. A variety of caching schemes can be implemented in this manner. The details of how this can be used to implement the concepts of the present disclosure are discussed below. The same write filter 204, or an associated read filter (not shown), then intercepts read requests for the same media and resolves them by retrieving cached data where it is available and by accessing the persistent storage where the data has not been cached.

A similar approach can be used to handle caching of data in the registry such as used in the Microsoft Windows® operating system. The Registry Hives 218 are typically structured as one or more files and/or directories on a persistent storage device. Requests to access registry data are received and processed by the Configuration Manager 206. In a manner analogous to the processing of IRPs, one or more Callback Handlers 208 can register with the Configuration Manager 206 and be notified when relevant registry requests are received. This enables caching of registry information. Requests which would modify the Registry Hives 218 can be cached in the same, or separate, Storage Cache 210 and requests which retrieve data can be checked against the cache and resolved from there if the data is available or from Persistent Storage 216 if it is not.

### Operation

In FIG. 2 decision 212 determines whether the data from a write operation should be cached or written through to persistent storage. The present disclosure addresses a specific approach to making this determination.

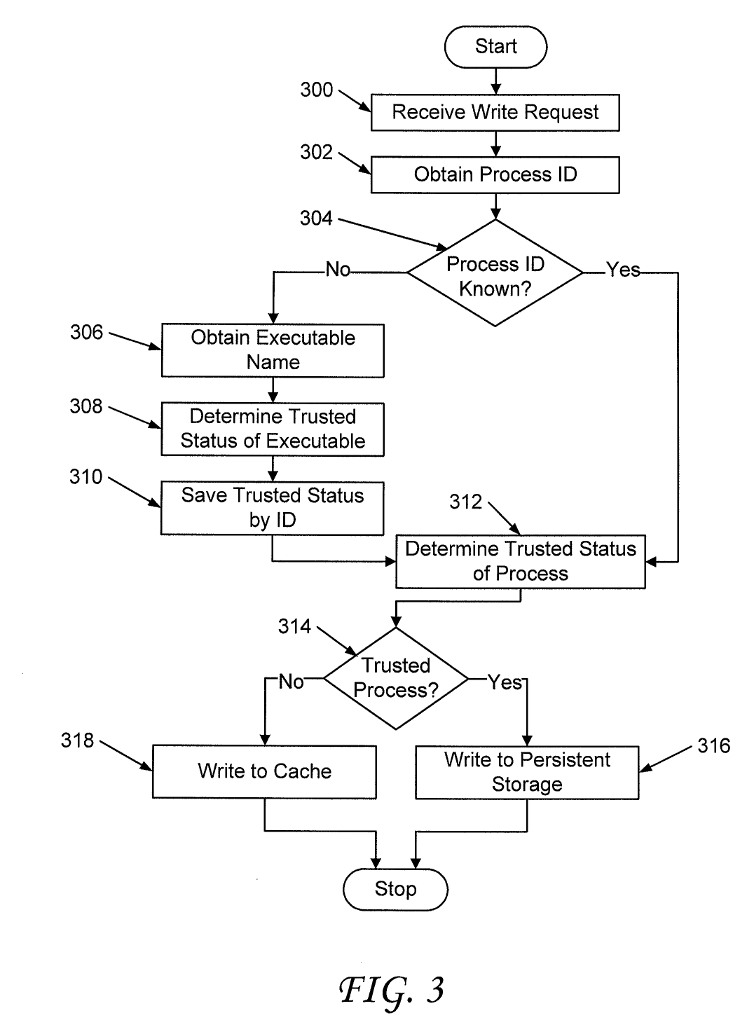

FIG. 3 illustrates the detailed steps in determining whether to cache or write-through a write request. The method of the present disclosure uses the concept of a trusted process. Trusted processes will be allowed to modify the data in persistent storage. Requests from all other processes will be diverted to cache. Determining whether a process is trusted is based on the executable file being run by that process.

Prior to making the system available for use, the administrator will identify those applications which are to be trusted. The criteria for this determination are up to the administrator but a typical selection might be a standard operating system application which is responsible for processing software updates, such as “update.exe” in the Microsoft Windows® operating system, or an equivalent application used by a third party developer. The names of the executable files for each these trusted applications will be configured as a set of persistent data available to the write filter. For additional security, all or part of the file system path name specifying the location of each file may also be stored.

While the data collection which holds the file names is referred to as a “set” herein, this is not intended to specify any particular data structure for the collection. Any appropriate structure (i.e., set, list, table, etc.) could be used within the scope of the present disclosure.

At run time, determining how a write request will be handled begins with the receipt of a write request at step 300. In addition to the data necessary for the write operation itself, the request contains information about the requesting process. In some environments, the process ID may be directly available in the request. In other environments, such as the Microsoft Windows® operating system, the process ID can be obtained in step 302 via a supplied function call such as FltGetRequestorProcess( ). The process ID, however obtained, provides an identifier which is guaranteed unique to a single executing process in the system. As such it is a reliable method of determining the source of the request.

Process IDs are often numeric values assigned by the operating system but for the purposes of the present disclosure any value associated with the process which uniquely distinguishes that process from all others executing on the same system is sufficient. Where the system allows the identifier to be specified so that it is consistent across system reboots, this identifier may be used in the above configuration step rather than the file name. This data set can then be preloaded at system boot so that all selected processes are immediately known to the system at step 304 as discussed below.

Two alternatives exist at step 304. The simplest case is that request has been received from a process which is already known to the system. That is, a previous request has been received from a process with that ID and the determination has already been made whether it is trusted or not. In this case, the process ID and the trusted status of the process have been recorded internally. The associated trusted status is retrieved at step 312 and evaluated at step 314. If the status indicates that the process is trusted, the data in the write request will be written to persistent storage, 316. If the process is not trusted, the data will be written to the storage cache, step 318, leaving the persistent data unmodified.

The second alternative at step 304 is that the process ID is not yet known to the system and the determination whether the process is trusted needs to be made. Process IDs are typically assigned by the operating system when the process is activated. This means that each time a particular application is executed it may be assigned a different process ID. As such, the process ID, by itself does not convey sufficient information to determine whether the process is to be trusted. What is needed is to identify the executable file which is being run by the process. Unlike the process ID, the file name is a relatively fixed value which is maintained by the file system. This allows it to be used to deterministically identify an application unaffected by system reboots.

Step 306 maps the process ID to the name of the associated executable file. An exemplary method, available in the Microsoft Windows® operating system is to use the PsGetProcessImageFileName( ) function, providing the appropriate input parameters including the process ID. The returned value is the executable file name. Equivalent capability is typically available in all operating systems.

With the file name available the determination of whether the process is trusted, step 308, is relatively straight forward. The system searches the preconfigured set of executable file names, and optional paths, which have been identified by the system administrator as being trusted. If the executable file associated with the current process is present in the set, then the process is trusted. If the executable file is not found in the set, then the process is not trusted. Either way, the trusted status is stored along with the process ID at step 310 and processing of the write request picks up at step 312 as described above. Alternatively, the preconfigured set could specify executable files which are not to be trusted with the default status being to trust the process.

Because the internal data on trusted status includes the process ID, write access to particular data is not “all or nothing” as it is with some other approaches. Two processes accessing the same data may be granted different access. The trusted process will be able to write to persistent storage and the non-trusted process will only be able to write to cache.

Where a non-trusted process has already written to a particular data item (i.e., file, directory, database entry, etc.) and a trusted process then requests a write to the same data item, a potential conflict arises. Once the data from the trusted process is written to persistent storage, the cached data becomes invalid. Generally this is handled by removing the data from the cache, or marking it invalid. Further, it is possible that the data being written by the trusted process may not reflect changes present in the cache. Invalidating the cached copy may cause loss of data written by non-trusted processes. Approaches to resolving these and similar issues are well known in the field and are equally applicable to the caching scheme of the present disclosure. If desired, more than one behavior may be supported and the selection of which approach to use can be policy driven.

As shown in FIG. 2 the above decision process for caching of data can be extended to address changes to more specific data sets, such as Registry keys, which are accessed via different interfaces. Rather than a generic I/O manager, the interface to user mode applications may be a task specific interface such as the Microsoft Windows® Configuration Manager, 206. The methods of the present disclosure can be readily adapted to this situation as long as a method exists to intercept the requests to modify the associated data. In the Microsoft Windows® example, a Callback Handler, 208, can register with the Configuration Manager to be notified when such a request is received. The Callback Handler then processes the request in an analogous manner to the write request discusses above. The process ID for the requestor is obtained via PsGetCurrentProcess( ), mapped to an executable file name via PsGetProcessimageFileName( ), and the file name checked against a set of trusted applications as above. Changes to the Registry keys are then either written through to the persistent storage, or cached, depending on whether the process is trusted or not.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1) A method of providing data caching for protected storage with write-through comprising:
(a) receiving a request to modify data which is resident on a protected storage;
(b) uniquely identifying a process which issued the data modification request;
(c) determining whether the process has been preselected as trusted; and
(d) if the process is trusted, allowing the data modification request to alter a data on the protected storage, else, recording the data modification in a data cache.

2) The method of claim 1 wherein the step of determining if the process has been preselected as trusted comprises retrieving a stored trusted state from a dynamic data set.

3) The method of claim 2 wherein the step of determining if the process has been preselected as trusted further comprises:
(a) failing to retrieve a trusted state from a dynamic data set;
(b) mapping the process to an associated application file name; and
(c) determining whether the associated application has been preselected as trusted.

4) The method of claim 3 further comprising storing the trusted state of the application in the dynamic data set as a trusted state for the process.

5) The method of claim 3 wherein the step of determining if the application has been preselected as trusted comprises retrieving a stored trusted state from a persistent data set.

6) The method of claim 5 wherein the step of determining if the application file name has been preselected as trusted further comprises failing to retrieve a trusted state from the persistent data set, and then specifying the state as non-trusted.

7) The method of claim 3 wherein the mapping of the process to an associated application file name includes at least a partial file system path in the application file name.

8) A computer system having selective write-though capability for a persistent storage device with data-caching, the computer system comprising:
(a) a persistent data storage device;
(b) a data storage cache;
(c) a write filter adapted to receive a plurality of write requests for the data storage device, the filter comprising the capability to:
(i) obtain a unique process ID for a process which issued each of the plurality of write requests;
(ii) determine whether the unique process ID has been identified as belonging to a trusted process; and
(iii) if the process is trusted, allowing each of the plurality of write requests to alter a data on the protected storage, else, recording each of the plurality of write requests in a data cache.

9) The system of claim 8 further comprising a dynamic data set having a trusted state recorded for each of one or more process IDs, wherein the capability to determine whether the process ID has been identified as belonging to a trusted process comprises retrieving a trusted state associated with the process ID of the process which issued the write request.

10) The system of claim 9 wherein retrieving the trusted state from the dynamic data set may not return trusted state data and the capability to determine whether the process ID has been identified as belonging to a trusted process further comprises the capability to map a process ID to an executable application name and determine if the application has been identified a being trusted and using this trusted state in place of the trusted state data not retrieved from the dynamic data set. may not return trusted state data

11) The system of claim 10 further comprising a persistent data set having a trusted state recorded for each of one or more executable application names and wherein the capability to determine if the application has been identified as being trusted comprises retrieving a trusted state associated with the executable application name.

12) The system of claim 11 wherein after retrieval from the persistent data set, the trusted state associated with the executable application name is stored in the dynamic data set associated with the process ID of the process which issued the write request.

13) The system of claim 11 wherein the system further comprises a logical file system and the persistent data set utilizes an executable file names as the application names.

14) The system of claim 13 wherein the executable file name comprises at least a partial logical file system path.

15) A cache write-through method comprising:
(a) pre-selecting a set of application names to be trusted;
(b) storing the pre-selected application names in a persistent data set;
(c) making the persistent data set available to a write filter which receives a plurality of write requests intended to modify protected data;
(d) determining by the write filter a process ID of an originating process for each of said plurality of write requests it receives;
(e) checking by the filter the process ID against a dynamic set of trusted processes;
(i) if the process ID is listed as being trusted, allowing the write request to proceed; and
(ii) if the process ID is listed as being non-trusted, diverting the write request to a cache; and
(f) if the write filter does not find the process ID in the dynamic data set;
(i) mapping by the write filter the process ID to an associated executable application name;
(ii) checking by the write filter each application name against those listed in the persistent data set; and
(A) if the application name is in the persistent data set, allowing the write request to proceed; and
(B) if the application name is not in the persistent data set, diverting the write request to the cache.

16) The method of claim 15 wherein the application name is a file name.

17) The method of claim 16 wherein the application name comprises at least a partial path name.

18) The method of claim 16 further comprising the step of:
if the application name is found in the persistent data set, adding a process ID of the an originating process to the dynamic data store as being trusted, else, adding the process ID of the originating process to the dynamic data store as being non-trusted.
